(19) United States
(12) Patent Application Publication
(10) Pub. No.: US 2024/0263062 A1
(43) Pub. Date: Aug. 8, 2024

(54) URETHANE HAVING IMPROVED INSULATION PERFORMANCE AND REFRIGERATOR HAVING SAME APPLIED THERETO

(71) Applicant: SAMSUNG ELECTRONICS CO., LTD., Suwon-si (KR)

(72) Inventors: Jongsung PARK, Suwon-si (KR); Mingyu JUNG, Suwon-si (KR); Youngdeog KOH, Suwon-si (KR); Jungsoo LIM, Suwon-si (KR); Sungmin CHO, Suwon-si (KR)

(73) Assignee: SAMSUNG ELECTRONICS CO., LTD., Suwon-si (KR)

(21) Appl. No.: 18/640,475

(22) Filed: Apr. 19, 2024

Related U.S. Application Data
(63) Continuation of application No. PCT/KR22/16447, filed on Oct. 26, 2022.

(30) Foreign Application Priority Data
Dec. 21, 2021 (KR) 10-2021-0184249

(51) Int. Cl. C09K 5/08; F25D 23/06

(52) U.S. Cl. CPC C09K 5/08; F25D 23/063; F25D 23/065; F25D 2201/1262

(57) ABSTRACT

The invention disclosed in the present specification relates to urethane that has insulation performance improved by lowering the thermal conductivity of urethane, and to a refrigerator having same applied thereto. The urethane having improved insulation performance comprising a plurality of closed cells containing internal gas generated from foaming; a plurality of open cells connected to outside air; and cell walls arranged between a closed cell among the plurality of closed cells and an open cell among the plurality of open cells or between the plurality of closed cells to connect the closed cells and the open cells, or the plurality of closed cells; and have a thermal conductivity (λᵤᵣₑₜₕₐₙₑ) 17 to 18.5 mW/m·K.

### CROSS-REFERENCE TO RELATED APPLICATION

This application is a continuation application, under 35 U.S.C. § 111(a), of international application No. PCT/KR2022/016447, filed on Oct. 26, 2022, which claims priority under 35 U. S. C. § 119 to Korean Patent Application No. 10-2021-0184249, filed Dec. 21, 2021, the disclosures of which are incorporated herein by reference in their entireties.

### BACKGROUND

### Technical Field

The disclosure relates to urethane with enhanced insulation performance and refrigerator using the same, and more particularly, to urethane having insulation performance improved by reducing thermal conductivity of the urethane and a refrigerator using the same.

### Description of the Related Art

In general, insulation for blocking heat from flowing in and out is indispensable to home appliances such as refrigerators. Especially, as environmental regulations are reinforced worldwide, low-energy consumption type home appliances are required. Hence, there is a growing demand for exterior materials for home appliance products with better insulation performance.

Urethane used for insulation is injected in a liquid state between the cabinet and cavity of a refrigerator, and forms a wall in a hardened state. The lowest thermal conductivity of the traditional insulation made of urethane has a limit of 20 mW/m·K, making it difficult to satisfy the reinforcement of the environmental regulations.

There is a method of increasing thickness of the urethane to increase insulation effects of the insulation. However, in the case of increasing the thickness of the urethane, the volume of the refrigerator increases or the storage capacity is reduced.

Furthermore, aerogel insulation or vacuum insulation having better insulation performance than the urethane costs very high, making it less competitive in price.

### SUMMARY

According to an embodiment of the disclosure, urethane having enhanced insulation performance includes a plurality of closed cells that contain internal gas generated from foaming; a plurality of open cells linked to outside air; and cell walls arranged between a closed cell among the plurality of closed cells and an open cell among the plurality of open cells or between the plurality of closed cells to connect the closed cell to the open cell or connect between the plurality of closed cells, wherein thermal conductivity λurethane is 17 to 18.5 mW/m·K.

In an embodiment of the disclosure, the urethane having enhanced insulation performance may include, in terms of volume fraction, 92 to 93% of the plurality of closed cells and 7 to 8% of the plurality of open cells.

In an embodiment of the disclosure, the urethane having enhanced insulation performance may have the cell walls, an average thickness of which may be 0.7 μm or less.

In an embodiment of the disclosure, in the urethane having enhanced insulation performance, the internal gas may include CO₂, cyclopentane (CP) and air.

In an embodiment of the disclosure, in the urethane having enhanced insulation performance, the internal gas may include, in terms of the volume fraction, 0.5 to 0.55 of CO₂, 0.36 to 0.41 of CP and the remaindered air.

In an embodiment of the disclosure, the urethane having enhanced insulation performance may have the closed cells, an average diameter of which may be 100 to 190 μm.

In an embodiment of the disclosure, the urethane having enhanced insulation performance may have a density of 19 to 40 kg/m³.

In an embodiment of the disclosure, in the urethane having enhanced insulation performance, the internal gas may include, in terms of the volume fraction, 0.42 to 0.50 of CO₂, 0.41 to 0.50 of CP and the remaindered air.

In an embodiment of the disclosure, the urethane having enhanced insulation performance may have the closed cells, an average diameter of which may be 100 to 240 μm.

In an embodiment of the disclosure, the urethane having enhanced insulation performance may have a density of 19 to 47 kg/m³.

In an embodiment of the disclosure, in the urethane having enhanced insulation performance, the internal gas may include, in terms of the volume fraction, 0.34 to 0.42 of CO₂, 0.50 to 0.57 of CP and the remaindered air.

In an embodiment of the disclosure, the urethane having enhanced insulation performance may have the plurality of closed cells, an average diameter of which may be 100 to 290 μm.

In an embodiment of the disclosure, the urethane having enhanced insulation performance may have a density of 19 to 55 kg/m³.

According to an embodiment of the disclosure, a refrigerator having enhanced insulation performance includes a cabinet arranged on an outermost side of the refrigerator; a cavity formed on an inner wall of the refrigerator; and urethane arranged between the cabinet and the cavity, wherein thermal conductivity λurethane of the urethane is 17 to 18.5 mW/m·K.

In an embodiment of the disclosure, in the refrigerator having enhanced insulation performance, the urethane may include a plurality of closed cells that contain internal gas generated from foaming; a plurality of open cells linked to outside air; and cell walls arranged between a closed cell among the plurality of closed cells and an open cell among the plurality of open cells or between the plurality of closed cells to connect the closed cell to the open cell or connect between the plurality of closed cells.

In an embodiment of the disclosure, in the refrigerator having enhanced insulation performance, the urethane may include, in terms of volume fraction, 92 to 93% of the plurality of closed cells and 7 to 8% of the plurality of open cells.

In an embodiment of the disclosure, in the refrigerator having enhanced insulation performance, the urethane may have the cell walls, an average thickness of which may be 0.7 μm or less.

In an embodiment of the disclosure, in the refrigerator having enhanced insulation performance, the internal gas may include CO₂, cyclopentane (CP) and air.

In an embodiment of the disclosure, the urethane having enhanced insulation performance may have a thermal conductivity λᵤᵣₑₜₕₐₙₑ of 17 to 18.5 mW/m·K, and the internal gas may include CO₂, Cyclopentane (CP) and air.

In an embodiment of the disclosure, the urethane having enhanced insulation performance may include the plurality of closed cells and the plurality of open cells, wherein an average thickness of the cell walls may be 0.7 μm or less.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a picture of a cross-section of urethane captured by a scanning electron microscope (SEM), according to an example of the disclosure.

FIG. 2 is a schematic diagram illustrating a cross-section of a refrigerator, according to an example of the disclosure.

### DETAILED DESCRIPTION

Reference will now be made in detail to embodiments, which are illustrated in the accompanying drawings. The following embodiments are provided as examples to convey the full spirit of the disclosure to those of ordinary skill in the art to which the embodiments of the disclosure belong. The disclosure is not limited to the embodiments but may be specified in any other forms. In the drawings, unrelated part of the description is not shown to clarify the disclosure, and the size of an element may be a little exaggerated to help understanding.

Throughout the specification, the term “include (or including)” or “comprise (or comprising)” is inclusive or open-ended and does not exclude additional, unrecited components, elements or method steps, unless otherwise stated.

It is to be understood that the singular forms “a,” “an,” and “the” include plural references unless the context clearly dictates otherwise.

According to an embodiment of the disclosure, urethane having enhanced insulation performance includes a plurality of closed cells including internal gas; a plurality of open cells linked to outside air; and cell walls arranged between the closed cell and the open cell or between the plurality of closed cells to connect the closed cell to the open cell or connect between the plurality closed cells.

To solve the above problem, an objective of the disclosure is to provide urethane having insulation performance enhanced by control wall thickness, internal gas mole fraction, a closed cell diameter, urethane density, etc., to reduce thermal conductivity of the urethane, and a refrigerator using the same.

According to an example of the disclosure, urethane having insulation performance enhanced by controlling cell wall thickness, internal gas mole fraction, a closed cell diameter, urethane density, etc., to reduce thermal conductivity of the urethane, and a refrigerator using the same may be provided.

According to an example of the disclosure, a refrigerator that may secure price competitiveness by suppressing a rise in cost and have wide internal capacity by using relatively thin urethane may be provided.

Effects that may be attained by urethane with enhanced insulation performance and refrigerator using the same according to embodiments of the disclosure are not limited to what are described above, and throughout the specification, it will be clearly appreciated by those of ordinary skill in the art that there may be other effects unmentioned.

According to an embodiment of the disclosure, urethane having enhanced insulation performance includes a plurality of closed cells including internal gas; a plurality of open cells linked to outside air; and cell walls arranged between the closed cell and the open cell or between the plurality of closed cells to connect the closed cell to the open cell or connect between the plurality closed cells, wherein thermal conductivity λᵤᵣₑₜₕₐₙₑ may be 17 to 18.5 mW/m·K.

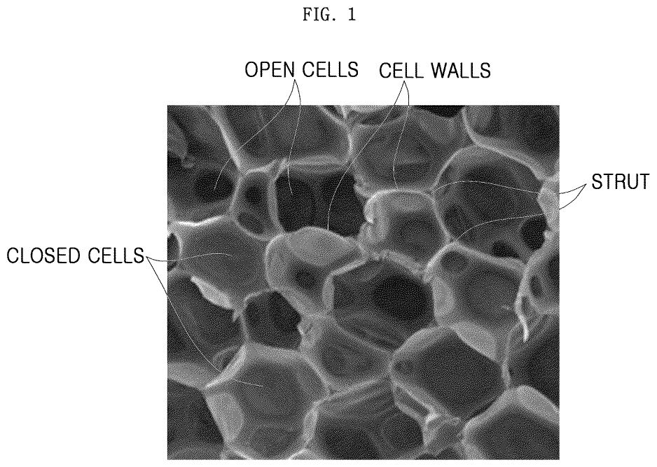

FIG. 1 is a picture of a cross-section of urethane captured by a scanning electron microscope (SEM), according to an example of the disclosure.

Referring to FIG. 1, urethane according to the example of the disclosure includes a plurality of open cells, a plurality of closed cells and cell walls.

The closed cell refers to a closed cavity that contains internal gas generated when urethane is foamed. The open cell refers to an open cavity that fails to form a closed cell but links to outside air.

The cell wall refers to a structure that is arranged between the closed cell and the open cell or between the plurality of closed cells to connect the closed cell to the open cell or connect between the plurality closed cells. Furthermore, a strut refers to a point where three or more of closed cells or open cells join.

The internal gas may include CO₂, cyclopentane (CP) and air.

In an embodiment of the disclosure, the urethane having enhanced insulation performance may have a thermal conductivity λᵤᵣₑₜₕₐₙₑ of 17 to 18.5 mW/m·K.

The urethane thermal conductivity λᵤᵣₑₜₕₐₙₑ that determines insulation performance of the urethane may be calculated in the following equation (1):

$${λ}_{urethane} = {λ}_{gas} + {λ}_{solid} + {λ}_{radiation} + {λ}_{convection} \qquad Equation ( l )$$

The urethane thermal conductivity λᵤᵣₑₜₕₐₙₑ may be calculated as a sum of thermal conductivity λ_{gas} of internal gas contained in the closed cell, thermal conductivity λ_{solid} of the cell wall, thermal conductivity λ_{radiation} due to radiant energy generated from across the cell wall and internal gas and thermal conductivity λ_{convection} of convection generated by circulation of the internal gas. In general, however, the thermal conductivity of convention has little influence inside the urethane, and thus, does not factor into calculation of the urethane thermal conductivity λᵤᵣₑₜₕₐₙₑ.

To reduce the thermal conductivity λᵤᵣₑₜₕₐₙₑ of the urethane, the thermal conductivity λ_{gas} of internal gas contained in the closed cell, the thermal conductivity λ_{solid} of the cell wall, the thermal conductivity λ_{radiation} due to radiant energy generated from across the cell wall and internal gas need to be reduced.

The thermal conductivity λ_{gas} of internal gas may be expressed in the following equation (2):

$${λ}_{g} = {\sum }_{i = 1}^{n} \frac{{n}_{j} {λ}_{i}}{{\sum }_{j = 1}^{n} {n}_{j} {A}_{ij}} \qquad Equation ( 2 )$$

In equation (2), Aᵢⱼ may be expressed in the following equation (3):

$${A}_{ij} = \frac{{[ 1 + {{α}_{ij}^{0.5} ( {M}_{i} / {M}_{j} )}^{0.25} ]}^{2}}{{[ 8 \cdot ( 1 + {M}_{i} / {M}_{j} ) ]}^{0.5}} \qquad Equation ( 3 )$$

In equation (3), aᵢⱼ may be expressed in the following equation (4):

$${α}_{ij} = \frac{{μ}_{i} {M}_{j}}{{μ}_{j} {M}_{i}} \qquad Equation ( 4 )$$

In equations (2), (3) and (4), λ_{g} refers to λ_{gas}, nᵢ or nⱼ refers to the mole fraction of arbitrary gas i or j, λᵢ refers to thermal conductivity of arbitrary gas i, Mᵢ and Mⱼ refer to molecular weight of arbitrary gas i or j, and μᵢ or μⱼ refers to a viscosity coefficient of arbitrary gas i or j.

The mole fraction refers to a value obtained by dividing the volume ratio of the internal gas by 100.

The molecular weight of CO₂ of the internal gas is 44, the thermal conductivity of CO₂ is 15.7 mW/m·K, and the viscosity coefficient of CO₂ is 1.44*10⁻⁵.

Furthermore, the molecular weight of cyclopentane (CP) of the internal gas is 70, the thermal conductivity of CP is 12.7 mW/m·K, and the viscosity coefficient of CP is 4.37*10⁻⁴.

Moreover, the molecular weight of the air of the internal gas is 30, the thermal conductivity of the air is 25 mW/m·K, and the viscosity coefficient of the air is 1.79*10⁻⁵.

To reduce the thermal conductivity λ_{gas} of the internal gas, the mole fractions of the air and CO₂ need to be low and the mole fraction of cyclopentane (CP) needs to be high. In the meantime, it is difficult to control the mole fraction of the air due to the open cell structure that is bound to be formed when urethane is foamed. Hence, in the disclosure, the thermal conductivity λ_{gas} of the internal gas is to be reduced by controlling the mole fractions of CO₂ and cyclopentane (CP).

The thermal conductivity of the cell wall λ_{solid} may be expressed in the following equation (5):

$${λ}_{s} = ( \frac{2}{3} - \frac{{f}_{s}}{3} ) \cdot ( 1 - Φ ) \cdot {λ}_{pur} \qquad Equation ( 5 )$$

In equation (5), fₛ may be expressed in the following equation (6):

$${f}_{s} = 1 - ( \frac{3.46 t {ρ}_{s}}{d {ρ}_{f}} ) \qquad Equation ( 6 )$$

In equation (6), φ may be expressed in the following equation (7):

$$Φ = 1 - \frac{{ρ}_{foam}}{{ρ}_{s}} \qquad equation ( 7 )$$

In equations (5), (6) and (7), As refers to λ_{solid}, fₛ refers to a strut fraction, φ refers to porosity, λₚᵤᵣ refers to thermal conductivity of urethane in a non-foamed solid state, t refers to average thickness of the cell walls, d refers to an average diameter of the closed cells, ρₛ refers to a density of urethane in the non-foamed solid state, and ρᵣ and ρ_{foam} refer to densities of foamed urethane.

In the meantime, calculation is performed by putting 1250 kg/m³ to ρₛ (the density of urethane in a non-foamed solid state).

To reduce the thermal conductivity λ_{solid} of the cell wall, the density ρ_{f} of the foamed urethane and the value of the average thickness t of the cell walls need to be reduced and the average diameter d of the closed cells needs to be increased.

The thermal conductivity λ_{radiation} due to the radiant energy may be expressed in the following equation (8):

$${λ}_{radiation} = \frac{16 \cdot σ \cdot {T}^{3}}{3 \cdot K} \qquad Equation ( 8 )$$

In equation (8), K may be expressed in the following equation (9):

$$K = 4.1 \cdot \frac{\sqrt{\frac{{f}_{s} \cdot {ρ}_{f}}{{ρ}_{s}}}}{d} + [ \frac{( 1 - {f}_{s} ) \cdot {ρ}_{f}}{{ρ}_{s}} ] \cdot {K}_{w} \qquad Equation ( 9 )$$

In equation (9), fₛ may be expressed in the above equation (6):

In equations (8) and (9), σ refers to the Stefan Boltzmann constant, T refers to temperature, K refers to an extinction coefficient, fₛ refers to the strut fraction, ρ_{f} refers to the density of foamed urethane, ρₛ refers to the density of urethane in a non-foamed solid state, d refers to the average diameter of the closed cells, K_{w} refers to an extinction coefficient of the cell wall, and t refers to average thickness of the cell walls.

In the meantime, calculation is performed by putting 5.6704*10⁻⁸ W/m²·K to σ (the Stefan Boltzmann constant), 296 K to the temperature T, 1250 kg/m³ to ρₛ (the density of urethane in a non-foamed solid state) and 60000 m⁻¹ to K_{w} (the extinction coefficient of the cell wall).

To reduce the thermal conductivity λ_{radiation} due to the radiant energy, on the contrary to the thermal conductivity λ_{solid} of the cell wall, the density ρ_{f} of the foamed urethane needs to be increased and the average diameter d of the closed cells needs to be increased. Accordingly, to reduce the urethane thermal conductivity λᵤᵣₑₜₕₐₙₑ, suitable values need to be set to the urethane density ρ_{f} and the average diameter d of the closed cells. Furthermore, the thermal conductivity λ_{radiation} due to the radiant energy is calculated to be almost constant regardless of an increase or decrease in the average thickness t of the cell walls.

The term ‘average’ refers to an average value of values measured at arbitrary 5 points.

Calculation, which is performed by referring to equation (1), may result in 20 to 22 mW/m·K for the traditional urethane and 17 to 18.5 mW/m·K of the thermal conductivity λᵤᵣₑₜₕₐₙₑ for urethane according to an embodiment of the disclosure. Accordingly, compared to the traditional urethane, 5% or more of energy saving effect may be expected by enhancing insulation performance by reducing the thermal conductivity by 10% or more.

In an embodiment of the disclosure, the urethane having enhanced insulation performance may include, in terms of volume fraction, 92 to 93% of the plurality of closed cells and 7 to 8% of the plurality of open cells. In the meantime, insulation performance of urethane may be enhanced the higher the volume fraction of the closed sells.

In an embodiment of the disclosure, the urethane having enhanced insulation performance may have the cell walls, an average thickness of which may be 0.7 μm or less.

When the average thickness of the cell walls is overly thick, it is difficult to obtain a desired urethane thermal conductivity λᵤᵣₑₜₕₐₙₑ, so the insulation performance of the urethane may be reduced.

When the average diameter of the closed cells is small, the thermal conductivity λ_{solid} of the cell wall increases, and when the average diameter of the closed cell is large, the thermal conductivity λ_{radiation} due to radiant energy increases. Furthermore, when the urethane density is low, the thermal conductivity λ_{radiation} due to radiant energy increases, and when the urethane density is high, the thermal conductivity λ_{solid} of the cell wall increases.

Accordingly, to obtain a desired value of urethane thermal conductivity λᵤᵣₑₜₕₐₙₑ, there is a need to set suitable values of urethane density and average diameter of closed cells depending on the mole fraction of the internal gas.

In an embodiment of the disclosure, in the urethane having enhanced insulation performance, the internal gas may include, in terms of the volume fraction, 0.5 to 0.55 of CO₂, 0.36 to 0.41 of CP and the remaindered air. In this case, the average diameter of the closed cells may be 100 to 190 μm, and the urethane density may be 19 to 40 kg/m³.

In an embodiment of the disclosure, in the urethane having enhanced insulation performance, the internal gas may include, in terms of the volume fraction, 0.42 to 0.50 of CO₂, 0.41 to 0.50 of CP and the remaindered air. In this case, the average diameter of the closed cells may be 100 to 240 μm, and the urethane density may be 19 to 47 kg/m³.

In an embodiment of the disclosure, in the urethane having enhanced insulation performance, the internal gas may include, in terms of the volume fraction, 0.34 to 0.42 of CO₂, 0.50 to 0.57 of CP and the remaindered air. In this case, the average diameter of the closed cells may be 100 to 290 μm, and the urethane density may be 19 to 55 kg/m³.

A refrigerator having enhanced insulation performance according to another aspect of the disclosure will now be described.

According to an embodiment of the disclosure, a refrigerator having enhanced insulation performance may include a cabinet arranged on the outermost side of the refrigerator; a cavity formed on an inner wall of the refrigerator; and urethane arranged between the cabinet and the cavity, wherein thermal conductivity λᵤᵣₑₜₕₐₙₑ of the urethane may be 17 to 18.5 mW/m·K.

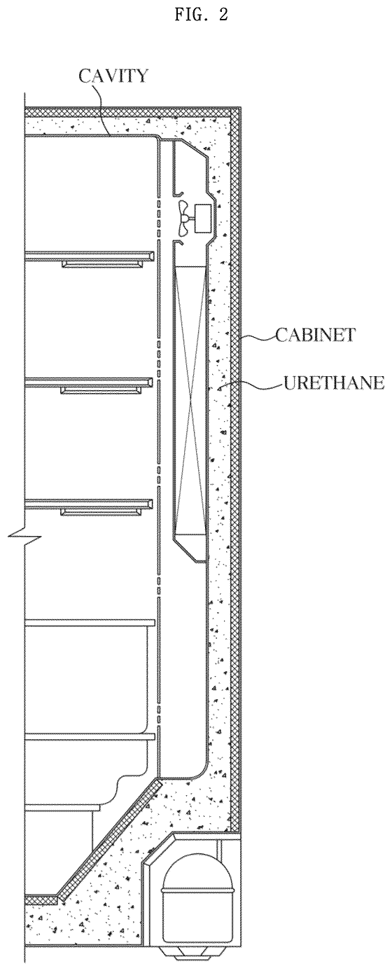

FIG. 2 is a schematic diagram illustrating a cross-section of a refrigerator, according to an example of the disclosure.

Referring to FIG. 2, a refrigerator having enhanced insulation performance according to an example of the disclosure may include a cabinet arranged on the outermost side and a cavity formed on an inner wall of the refrigerator, and urethane for insulation between the cabinet and the cavity.

The cabinet may consist of steel and the cavity may consist of plastic.

In an embodiment of the disclosure, in the refrigerator having enhanced insulation performance, the urethane may include a plurality of closed cells including internal gas; a plurality of open cells linked to outside air; and structures arranged between the closed cell and the open cell or between the plurality of closed cells to connect the closed cell to the open cell or connect between the plurality closed cells.

In an embodiment of the disclosure, in the refrigerator having enhanced insulation performance, the urethane may include, in terms of volume fraction, 92 to 93% of the plurality of closed cells and 7 to 8% of the plurality of open cells.

In an embodiment of the disclosure, in the refrigerator having enhanced insulation performance, the urethane may have the cell walls, an average thickness of which may be 0.7 μm or less.

In an embodiment of the disclosure, in the refrigerator having enhanced insulation performance, the internal gas may include CO₂, cyclopentane (CP) and air.

An embodiment and a comparative example will now be described to help understand the disclosure. However, the following description and effects are merely an example of the disclosure, and the scope and effect of the disclosure is not limited thereto.

### Embodiment

Table 1 below represents values of urethane thermal conductivity λᵤᵣₑₜₕₐₙₑ, mW/m·K calculated depending on the average diameter of the closed cells and density of the urethane when average thickness of cell walls is 0.2 μm and the mole fraction of the internal gas has 0.547 of CO₂ and 0.366 of CP.

TABLE 1

| | | average diameter of closed cells | | |
|---|---|---|---|---|
| | | (μm) | | |
| | | 100 | 142 | 226 |
| density of | 19 | 18.2 | 18.6 | 19.6 |
| urethane | 25 | 18.3 | 18.6 | 19.5 |
| (kg/m³) | 31 | 18.5 | 18.8 | 19.6 |
| | 43 | 19.1 | 19.3 | 20.0 |

Table 2 below represents values of urethane thermal conductivity λᵤᵣₑₜₕₐₙₑ, mW/m K calculated depending on the average diameter of the closed cells and density of the urethane when average thickness of cell walls is 0.2 μm and the mole fraction of the internal gas has 0.507 of CO₂ and 0.406 of CP.

TABLE 2

| | | average diameter of closed cells | | |
|---|---|---|---|---|
| | | (μm) | | |
| | | 100 | 142 | 226 |
| density of | 19 | 18.0 | 18.4 | 19.4 |
| urethane | 25 | 18.1 | 18.4 | 19.3 |
| (kg/m³) | 31 | 18.3 | 18.6 | 19.4 |
| | 43 | 18.9 | 19.1 | 19.8 |

Referring to tables 1 and 2, when the average thickness of the cell walls is 0.7 μm or less, the mole fraction of the internal gas includes 0.5 to 0.55 of CO₂, 0.36 to 0.41 of CP and the remaindered air, the average diameter of the closed cells is 100 to 190 μm, and the density of urethane satisfies 19 to 40 kg/m′, it may be seen that the urethane thermal conductivity λᵤᵣₑₜₕₐₙₑ may satisfy 17 to 18.5 mW/m·K.

Table 3 below represents values of urethane thermal conductivity λᵤᵣₑₜₕₐₙₑ, mW/m·K calculated depending on the average diameter of closed cells and density of urethane when average thickness of cell walls is 0.2 μm and the mole fraction of the internal gas has 0.487 of CO₂ and 0.426 of CP.

TABLE 3

| | | average diameter of closed cells | | |
|---|---|---|---|---|
| | | (μm) | | |
| | | 100 | 184 | 268 |
| density of | 19 | 17.9 | 18.7 | 19.8 |
| urethane | 25 | 17.9 | 18.7 | 19.6 |
| (kg/m³) | 36.9 | 18.4 | 19.0 | 19.8 |
| | 49 | 19.1 | 19.6 | 20.2 |

Table 4 below represents values of urethane thermal conductivity λᵤᵣₑₜₕₐₙₑ, mW/m·K calculated depending on the average diameter of closed cells and density of urethane when average thickness of cell walls is 0.2 μm and the mole fraction of the internal gas has 0.427 of CO₂ and 0.486 of CP.

TABLE 4

| | | average diameter of closed cells | | |
|---|---|---|---|---|
| | | (μm) | | |
| | | 100 | 184 | 268 |
| density of | 19 | 17.5 | 18.3 | 19.4 |
| urethane | 25 | 17.6 | 18.3 | 19.3 |
| (kg/m³) | 36.9 | 18.0 | 18.6 | 19.4 |
| | 49 | 18.7 | 19.2 | 19.9 |

Referring to tables 3 and 4, when the average thickness of the cell walls is 0.7 μm or less, the mole fraction of the internal gas includes 0.42 to 0.50 of CO₂, 0.41 to 0.50 of CP and the remaindered air, the average diameter of the closed cells is 100 to 240 μm, and the density of urethane satisfies 19 to 47 kg/m′, it may be seen that the urethane thermal conductivity λᵤᵣₑₜₕₐₙₑ may satisfy 17 to 18.5 mW/m·K.

Table 5 below represents values of urethane thermal conductivity λᵤᵣₑₜₕₐₙₑ, mW/m·K calculated depending on the average diameter of closed cells and density of urethane when average thickness of cell walls is 0.2 μm and the mole fraction of the internal gas has 0.387 of CO₂ and 0.526 of CP.

TABLE 5

| | | average diameter of closed cells | | |
|---|---|---|---|---|
| | | (μm) | | |
| | | 100 | 184 | 310 |
| density of | 19 | 17.2 | 18.1 | 19.7 |
| urethane | 31 | 17.5 | 18.2 | 19.5 |
| (kg/m³) | 43 | 18.1 | 18.6 | 19.7 |
| | 55 | 18.8 | 19.2 | 20.2 |

Table 6 below represents values of urethane thermal conductivity λᵤᵣₑₜₕₐₙₑ, mW/m·K calculated depending on the average diameter of closed cells and density of urethane when average thickness of cell walls is 0.2 μm and the mole fraction of the internal gas has 0.347 of CO₂ and 0.566 of CP.

TABLE 6

| | | average diameter of closed cells | | |
|---|---|---|---|---|
| | | (μm) | | |
| | | 100 | 184 | 310 |
| density of | 19 | 17.0 | 17.8 | 19.5 |
| urethane | 31 | 17.2 | 17.9 | 19.2 |
| (kg/m³) | 43 | 17.8 | 18.4 | 19.5 |
| | 55 | 18.5 | 19.0 | 19.9 |

Referring to tables 5 and 6, when the average thickness of the cell walls is 0.7 μm or less, the mole fraction of the internal gas includes 0.34 to 0.42 of CO₂, 0.50 to 0.57 of CP and the remaindered air, the average diameter of the closed cells is 100 to 290 μm, and the density of urethane satisfies 19 to 55 kg/m′, it may be seen that the urethane thermal conductivity λᵤᵣₑₜₕₐₙₑ may satisfy 17 to 18.5 mW/m·K.

### INDUSTRIAL APPLICABILITY

According to an example of the disclosure, urethane having insulation performance enhanced by controlling cell wall thickness, internal gas mole fraction, a closed cell diameter, an urethane density, etc., to reduce thermal conductivity of the urethane, and a refrigerator using the same may be provided.

What is claimed is:

1. Urethane having enhanced insulation performance comprising:
a plurality of closed cells that contain internal gas generated from foaming;
a plurality of open cells linked to outside air; and
cell walls arranged between a closed cell among the plurality of closed cells and an open cell among the plurality of open cells or between the plurality of closed cells to connect the closed cell to the open cell or connect between the plurality of closed cells,
wherein thermal conductivity λᵤᵣₑₜₕₐₙₑ is 17 to 18.5 mW/m·K.

2. The urethane having enhanced insulation performance of claim 1, wherein, in terms of volume fraction, the plurality of closed cells are 92 to 93% and the plurality of open cells are included in 7 to 8%.

3. The urethane having enhanced insulation performance of claim 1, wherein an average thickness of the cell walls is 0.7 μm or less.

4. The urethane having enhanced insulation performance of claim 1, wherein the internal gas comprises CO₂, cyclopentane (CP) and air.

5. The urethane having enhanced insulation performance of claim 4, wherein the internal gas comprises, in mole fraction, 0.5 to 0.55 of CO₂, 0.36 to 0.41 of CP and remaindered air.

6. The urethane having enhanced insulation performance of claim 5, wherein the plurality of closed cells have an average diameter of 100 to 190 μm.

7. The urethane having enhanced insulation performance of claim 5, wherein the urethane has a density of 19 to 40 kg/m³.

8. The urethane having enhanced insulation performance of claim 4, wherein the internal gas comprises, in mole fraction, 0.42 to 0.50 of CO₂, 0.41 to 0.50 of CP and remaindered air.

9. The urethane having enhanced insulation performance of claim 8, wherein the plurality of closed cells have an average diameter of 100 to 240 μm.

10. The urethane having enhanced insulation performance of claim 8, wherein the urethane has a density of 19 to 47 kg/m³.

11. The urethane having enhanced insulation performance of claim 4, wherein the internal gas comprises, in mole fraction, 0.34 to 0.42 of CO₂, 0.50 to 0.57 of CP and remaindered air.

12. The urethane having enhanced insulation performance of claim 11, wherein the plurality of closed cells have an average diameter of 100 to 290 μm.

13. The urethane having enhanced insulation performance of claim 11, wherein the urethane has a density of 19 to 55 kg/m³.

14. A refrigerator having enhanced insulation performance comprising:
a cabinet arranged on an outermost side of the refrigerator;
a cavity formed on an inner wall of the refrigerator; and
urethane arranged between the cabinet and the cavity,
wherein thermal conductivity λᵤᵣₑₜₕₐₙₑ of the urethane is 17 to 18.5 mW/m·K.

15. The refrigerator having enhanced insulation performance of claim 14, wherein the urethane comprises:
a plurality of closed cells that contain internal gas generated from foaming;
a plurality of open cells linked to outside air; and
cell walls arranged between a closed cell among the plurality of closed cells and an open cell among the plurality of open cells or between the plurality of closed cells to connect the closed cell to the open cell or connect between the plurality of closed cells.
